(19) United States
(12) Patent Application Publication
(10) Pub. No.: US 2004/0160364 A1
(43) Pub. Date: Aug. 19, 2004

(54) Digital instantaneous direction finding system

(76) Inventor: Zvi Regev, West Hills, CA (US)

Correspondence Address: ZVI REGEV, 24217 HIGHLANDER RD., WEST HILLS, CA, 91307, US

(21) Appl. No.: 10/696,147

(22) Filed: Oct. 28, 2003

Related U.S. Application Data
(60) Provisional application No. 60/421,855, filed on Oct. 29, 2002.

(51) Int. Cl. G01S 5/04

(52) U.S. Cl. 342/432

(57) ABSTRACT

A system for finding the instantaneous spatial azimuth and elevation of a source of radio signals employing phase digitizers to measure the phase of arrival of a radio signal on an array of antennas. The phase digitizers providing digital indication of the phase of arrival, enable the determination of the azimuth, and elevetion of a source of radio signal, utilizing simple digital subtraction methods.

### FIELD OF THE INVENTION

This invention generally relates to passive direction finding antenna systems for radio waves, and in particularly to antenna arrays that continuously observe over 360 degree arc in space, to determine the spatial direction of an incoming wave, and produce a digital output code, representing the direction of the incoming wave.

### DESCRIPTION OF THE PRIOR ART

Many prior art methods of detecting the spatial direction of incoming radio signals are used, utilizing rotating focused antenna beams, as well as circular antenna arrays and direction finding receivers. Burnham and Clark, describe a direction finding system wherein the system employs a circular antenna array energizing a phase shifting network that produces output signals whose time phase is directly proportional to a spatial angle of an incoming RF signal. Thus for each different spatial angle of an incoming RF signal the system produces a different time phase angle, which is sampled and digitized to produce a digital output.

### BACKGROUND OF THE INVENTION

In the simplest form of an antenna array used for direction finding, two antennas are used, as shown in FIG. 1. The RF signal phase delay, between antenna 1, and antenna 2, is:

$$Δ φ = \frac{2 Π f}{C} A sin θ ,$$

wherein Δφ is the phase difference between the antennas, f is the RF signal frequency, C is the speed of light, A is the distance between the antennas, and θ is the angle of arrival of the RF signal. In this equation, A and C are constant, f and Δφ must be measured, and θ is the unknown which the system needs to find. From the equation above, is results that

$$θ = arc sin \frac{( Δ φ ) C}{2 Π fA} = arcsin \frac{( Δ φ )}{2 Π } \times \frac{C}{Af} .$$

This invention describes a novel method of measuring the parameters f and Δφ, in order to calculate the angle of arrival θ.

The array of two antennas can measure angle of arrival (azimuth) with respect to the boresight axis which is perpendicular to the axis common to the two antennas. In a case shown in FIG. 2, the source of the RF signal may be on either side of the axis line connecting the two antennas. The array of two antennas, as shown in FIG. 2, is unable to determine which side of the axis line a signal source is located. This problem is solved, by placing two more antennas, on an axis parallel to the boresight axis of the first two antennas, as shown in FIG. 3. The array of four antennas divides the horizontal plane to four quadrons, and thus an emitter can be located to one quadron and eliminate the ambiguity associated with the array of two antennas.

The array of four antennas is viewed as comprised of two pairs of antennas. One pair is located on a horizontal axis named the “I” axis, and the other pair the is located on the horizontal axis named the “Q” axis. Each pair of antennas can determine the azimuth of an RF signal on all 360° around it, but with ambiguity with regards to which side of the axis it is located. As can be seen from FIG. 1, when a transmitter is located on the boresight line, stright in front of the pair of antennas, the two antennas will receive the RF signal at the same phase. As the source of RF signal moves away from the boresight line, the phase difference between the two antennas increases, and peaks when the emitter is located on the same horizontal axis as the pair of antennas. This means that in every quadron, the azimuth measurement can be achieved using either pair of antennas, on either axis. However, since the phase difference Δφ, is directly proportional to sin θ, the best angular resolution is obtained when |θ|<45°. To obtain the best azimuth measurement, the measurement on either axis is limited to an azimuth between +45°, and −45° When |θ|>45°, the azimuth data is obtained from the pair of antennas on the alternate axis, as shown in FIG. 3.

The measurement of the angle of arrival of RF signals is not limited to the azimuth in the horizontal plane. The vertical angle, or elevation, of a source of RF signal can be measured in the same way horizontal azimuths are measured. Here an ambiguity exist, with regards to the location of the RF source, above, or below the horizontal plane on which the array of antennas is located. An additional antenna placed on a vertical axis Z, above one of the four other antennas, as shown in FIGS. 4, and 5, eliminates the ambiguity, and enables measuring azimuth and elevation both in the hemisphere above the horizontal plane of the antennas, and the hemisphere below.

Prior art direction finding methods are not based on the direct measurement of phases, but rather on summations of RF signals, or the ratios between RF signals.

In this invention each antenna is connected to a receiver, and the output of each receiver is connected to a phase digitizer. The phase digitizer is a device with a digital output indicating the instantaneous phase of the RF signal at its input, at the time of the instruction clock transition. The clock is typically a periodical signal at a high frequency, and the phase digitizer outputs a new word of data every clock cycle. The same clock is delivered to all the phase digitizers, such that the transition time will be exactly the same on all the digitizers. This guarantees that when a signal arrives at every antenna at exactly the same phase, all the phase digitizers will indicate the same phase, φ, on the same clock transition time. The value Δφ, is calculated simply by subtracting the phase data on one digitizer, from that of the second digitizer receiving signals from the second antenna in the pair of antennas. The result is Δφ=φ₁−φ₂, wherein φ₁ is the output of the phase digitizer receiving signals from antenna 1, and φ₂ is the output of the second phase digitizer, receiving signals from antenna 2 in the pair of antennas.

The other parameter necessary to calculate the angle of arrival is the frequency of the arriving signal. By definition, the frequency of the signal is the rate of change of it phase over a period of time,

$$f = \frac{ⅆ φ}{ⅆ t} .$$

The output of the phase digitizer is the instantaneous phase φₖ, and the clock period is t_{c}. Therefore, the instantaneous frequency of the incoming RF signal is

$$F = \frac{{φ}_{k} - {φ}_{k + 1}}{{t}_{c}} ,$$

wherein φₖ, is the instantaneous phase at time k, and φₖ₊₁, is the instantaneous phase one clock period later, at the time k+1.

To increase the accuracy of all the measurements, both Δφ, and F are averaged over a number (n) consecutive clock periods.

To guarantee the best angle resolution, it was determined that each pair of antennas will only be used in measuring angles between +45° and −45° Or, 101<45°. Digital magnitude comparators are used to compare between the phase difference measured on the different axes (I, Q, or Z), and determine which axis is used for the final measurement output.

The range of frequencies for which the direction finding system can provide a correct azimuth or elevation information is limited by a couple of conditions. The first limiting factor is the distance between the two antennas on an axis. If this distance is greater than the wavelength of the incoming RF signal, the system is unable to determine the exact phase difference between the antennas. A second limitation depends on the frequency of the clock. The Nyquist rule requires that the clock frequency is more the twice the highest frequency, or the frequency bandwidth, in the phase digitizer input. Together the distance between the antennas, and the clock frequency determine the operational limits of the system.

In some other applications for finding the direction of an emitter of radio signals, two directional antennas are used. Directional antennas exhibit a large gain for signals received in the forward direction of the antenna, and a large attenuation for signals coming from other directions, especially from the direction opposite to the antenna's forward direction. Such antennas include YAGI, and dish type antennas.

When an array of two directional antennas are used, wherein both antennas are facing the same direction, a direction finding system, to find the azimuth to a source of radio signals, within a semicircle of 180°, can be built. Since the antennas are highly directional, the direction finding system based on such antennas does not suffer the problem of ambiguity, as is the case with omnidirectional antennas typically used in other types of direction finding systems. A typical application for such direction finding system is in airplanes wherein an array of two directional antennas on the wings is used to construct a forward looking direction finding system.

In two other applications utilizing two directional antennas, one is the “monopulse” radar, and an electronic warfare system based on two directional antennas on an airplanes wings, known as “cross eye”, which is used to deceive the azimuth detection systems of hostile “monopulse” radars.

A “monopulse” type radar is comprised of two or more highly directional antennas, all aimed at the same direction, as shown in FIG. 13. In this type of a radar, two antennas are used to detect the direction of a target by comparing the phase difference between the two antennas, when a signal reflected from that target is received. The monopulse radar is designed such that the antennas are rotated until the reflected signal is received on both antennas at the same phase, indicationg that the antennas aim directly at the target. Such radars are typically used in the military for fire control, wherein these radars control the direction of fire towards the target.

The “cross eye” electronic warfare system shown in FIG. 14, is used on “target” airplanes to deceive hostile monopulse, or fire control radars, by obscuring the direction finding capabilities of the monopulse radar, and preventing it from aiming directly at a target. In the “cross eye” system, the monopulse radar signals is received by two forward-looking antennas mounted on both wings. The received signals are digitized and stored in a temporary memory. Subsequently the stored signals are recalled and retransmitted through the two antennas such the phase of the transmitted signals on either antenna is varied, resulting in two simultaneous signals being transmitted, which are identical in all their parameters except for their phase. The monpulse radar receiving the two signals of different phases is unable to determine the true direction from which these signals come, and thus is deceived and deprived of its direction finding capabilities.

### DESCRIPTION OF THE DRAWINGS

FIG. 1, Shows the phase relationship in an array of two antennas.

FIG. 2, Shows a case where RF emitter may be located on either sides of an antenna array.

FIG. 3, Shows an array of four antennas comprised of two arrays in quadrature.

FIG. 4, Shows an array of 5 antennas, for azimuth and elevation detection.

FIG. 5, Shows the phase relationship, and method for measurement of elevation angle.

FIG. 6, Shows an embodiment of the azimuth and elevation detection system.

FIG. 7, Shows an embodiment of a typical RF receiver.

FIG. 8, Shows a block diagram of a phase digitizer.

FIG. 9, Shows an embodiment of the quantizer section of the phase digitizer.

FIG. 10, Shows the waveforms at the outputs of the comparators.

FIG. 11, Shows the Linear to Grey code conversion.

FIG. 12, Shows the Grey code to Binary code conversion.

FIG. 13, Shows signals and phases in a “monopulse” type radar.

FIG. 14, Shows a block diagram of a “cross-eye” system.

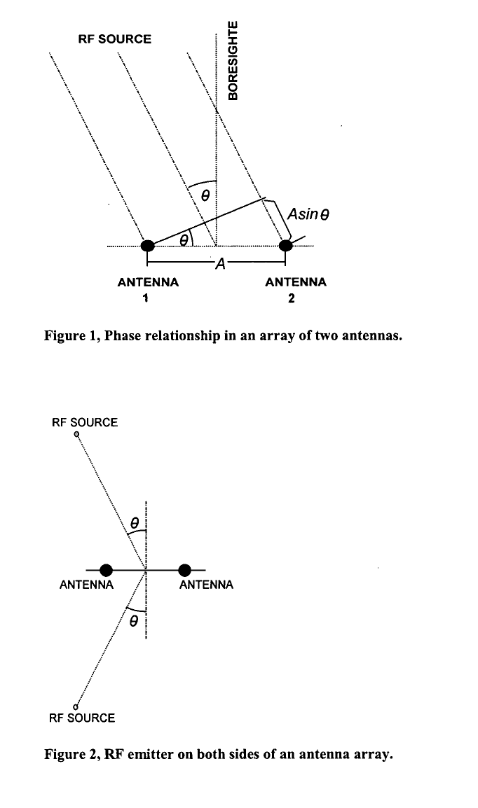

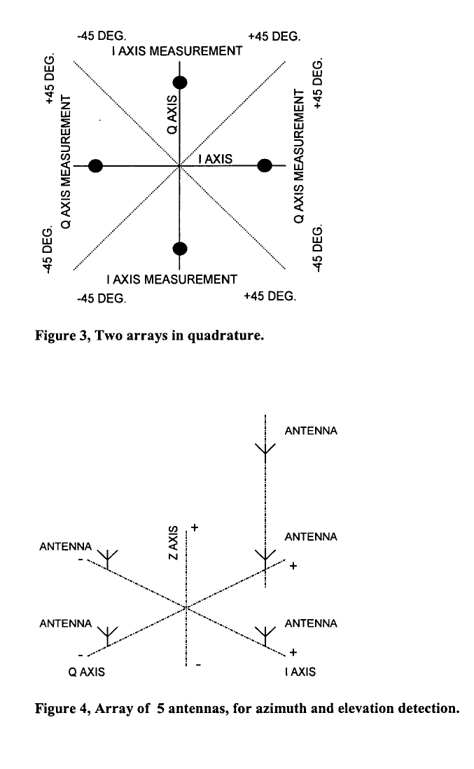

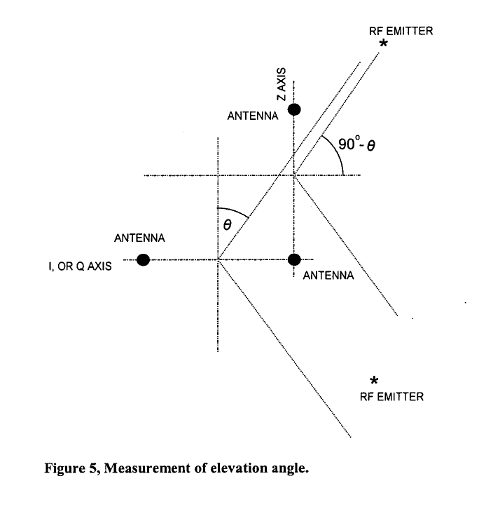

### DESCRIPTION OF THE INVENTION

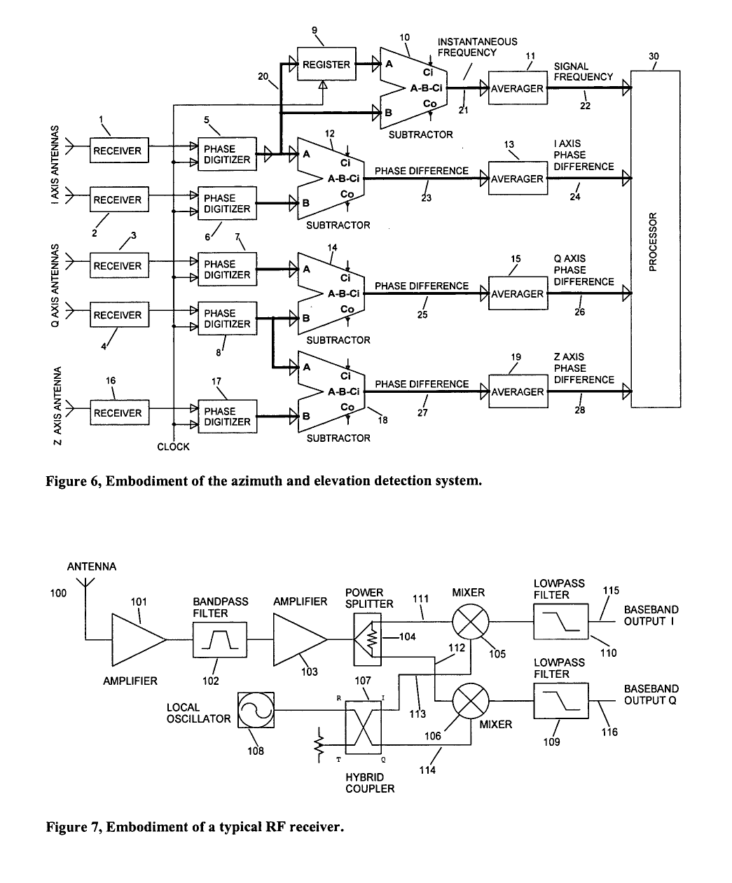

To better understand the description of this invention, refer to FIGS. 6, 7, and 8. FIG. 6 shows an embodiment of the system capable of determining the azimuth and elevation of an emitter of RF signal. As shown, 5 antennas are used, each connected to a radio frequency receiver. An embodiment of a typical RF receiver is shown in FIG. 7. The signal received by the antenna (100), is aplified by the amplifier (101), and then filtered by a bandpass filter (102). The bandpass filter guarantees that onlt signals at frequencies within the operational limits of the system are passed down to the system. The bandpass filter (102) is followed by another amplification stage (103). The output of the second amplification stage (103) connects to a power splitter (104) which splits the output of the amplifier (103) into two signals identical to the output of the amplifier (103) in all respects except for the power, which is divided, one half (111), and the other half (112), which are connected to the RF mixers (105) and (106) respectively.

Each of the mixers (105, 106) has three ports, an input (RF) port, a local oscillator (LO) port, and an output (IF) port. The function of the mixers is to multiply the signal on its input port with the signal on its LO port, to generate an output signal at two frequencies, one equals the frequency difference between the two inputs to the mixer, and the other that equals the sum of the two input frequencies. The input ports of the mixers are connected to the outputs of the power splitter (104). A local oscillator (108) generates a signal at a high frequency, such that when this signal is subtracted from the signal at the outputs of the splitter (104), will produce an output (IF) signal from the mixers, at a frequency smaller than half the clock frequency. The output of the local oscillator (108) is connected to the input of a hybrid coupler (107). The hybrid coupler is similar in it function to that of a power splitter, in dividing the power of a signal at its input between two lower power outputs. The hybrid coupler differs from the power splitter in having the phase of one of its outputs shifted by 90° with respect to phase of the other output. The outputs (113, 114) of the hybrid coupler (107) are connected to the LO ports of the mixers (105, 106), respectively.

The mixers which receive input signals on their LO inputs that are phase shifted by 90° from each other, poduce two low frequency outputs that are also phased 900 from each other, otherwise known in the trade of RF as a quadrature condition. The output of each mixer (105, or 106) is connected to a lowpass filter (109, or 110) respectively. The lowpass filters are selected such that they attenuate and eliminate any signal at a frequency higher than half the system clock frequency. The outputs (115, 116) of these lowpass filters (109, 110) are the baseband signals applied to the phase digitizer.

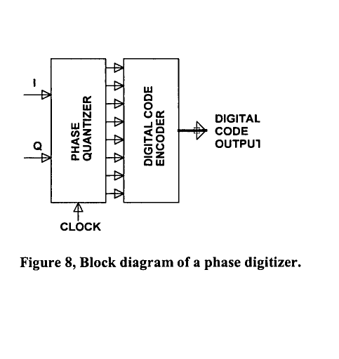

FIG. 8, shows a block diagram of a phase digitizer. As shown, the digitizer is comprised of two blocks, the quantizing block, and the code conversion block.

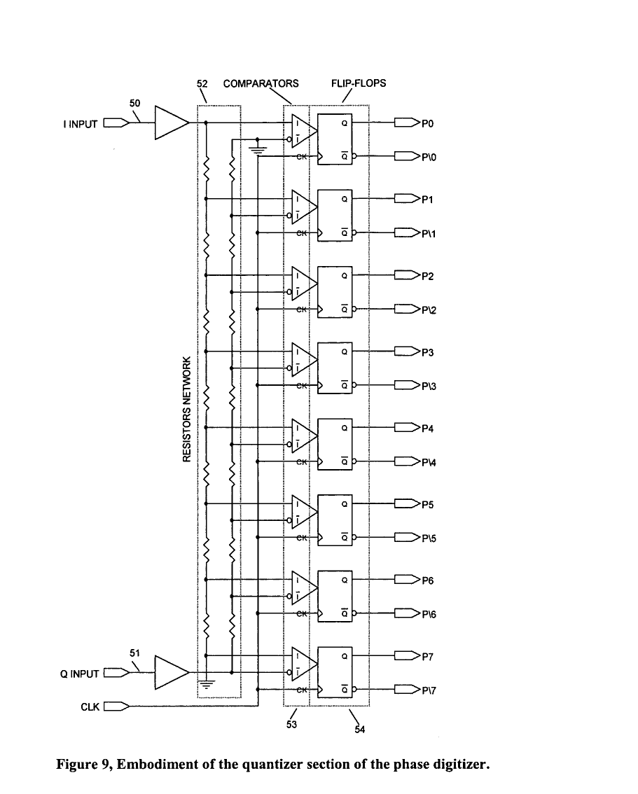

An embodiment of the quantizer block is shown in FIG. 9. The quantizer recieves two inputs, an I input (50), and a Q input (51), which are identical copies of each other, but are phase shifted by 90° from each other. These two inputs feed a network of resistors (52), which combine different ratios of the signals from the inputs (50, 51), to produce n signals, all of the same frequency, but phase shifted from one to another by

$$Δ Ψ = \frac{Π}{n}$$

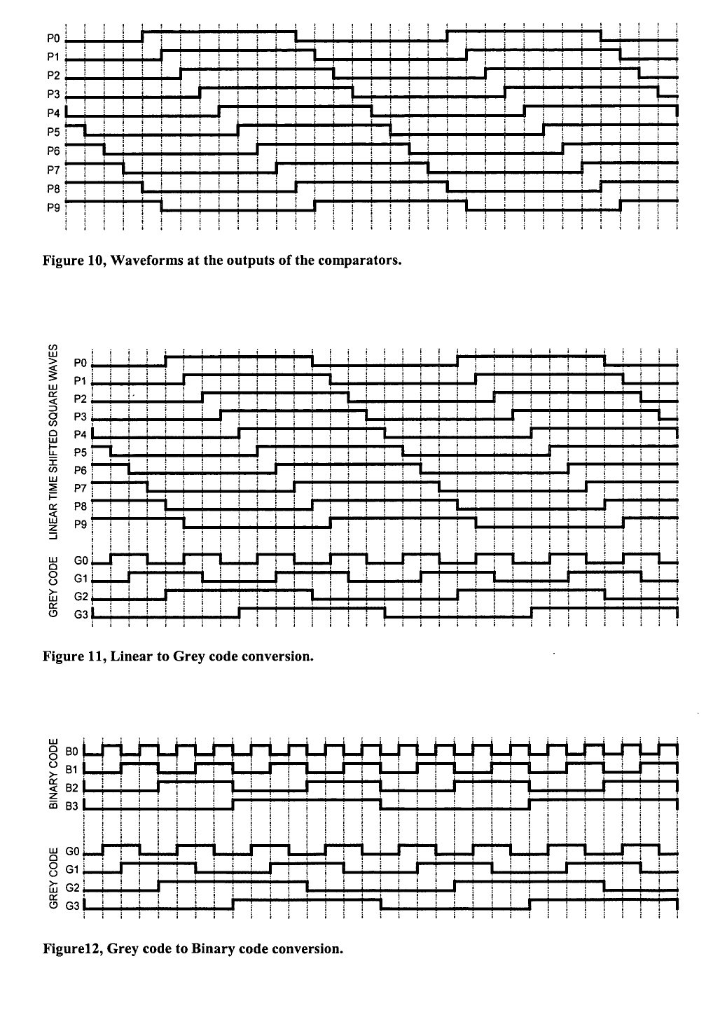

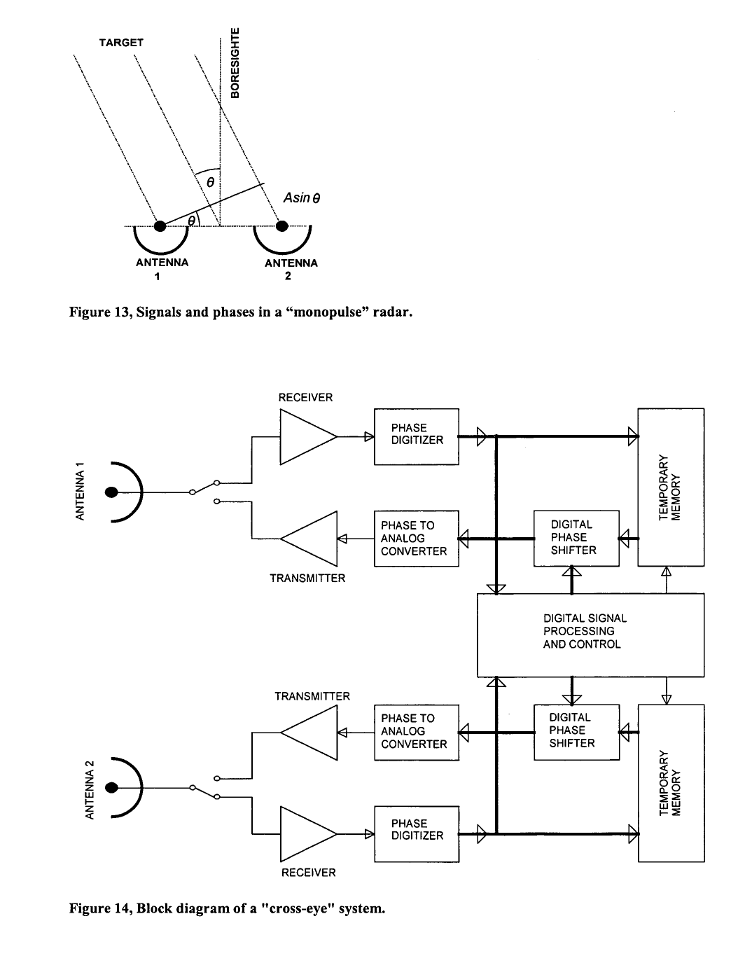

radians. The signals generated by the resistor network (52) are applied to the inputs on n comparators (53), which in turn generate n streams of phase (time) shifted squarewaves, which are applied to the D inputs of n master-slave type flip-flops (54). FIG. 10, shows the waveforms at the outputs of the comparators. The flip-flops (54) capture the waveforms generated by the comparators (53), on the transition of the clock, and each flip-flop (k) provides two complementary outputs Pₖ, and Pₖ\, which are in a linear code fasion, and need to be converted to a binary code.

The conversion of the linear code to a binary code is done in this embodiment, using a two steps process. In the first step, the linear code is translated into a Grey code using Exclusive OR functions as shown by an example for a digitizer where n=16: G0=P1⊕P3⊕P5⊕P7, G1=P2⊕P6, G2=P0, and G3=P4, as demonstrated in FIG. 11. The second step also utilizes EXOR functions, to convert the Grey code to a Binary code, as follows: B0=G0⊕G1⊕G2⊕G3, B1=G1⊕G2⊕G3, B2=G2⊕G3, and B3=G3. This conversion is demonstrated in FIG. 12.

What is claimed is:

1. A system for finding the instantaneous spatial direction of a source of radio signals comprising
A plurality of antennas;
A plurality of Radio Frequencies receivers, equal the number of antennas;
A plutality of phase digitizers, equal the number of antennas;
Devices to digitally calculate the the phase difference between ant two antennas;
Devices to digitally calculate the instantaneous frequency of a detected signal;
Devices to digitally calculate, from frequency and phase differences data, the azimuth of a source of radio signal.

2. A system for finding the instantaneous spatial direction of a source of radio signals as in claim 1, wherein the plurality of antennas is a minimum of three antennas.

3. A system for finding the instantaneous spatial direction of a source of radio signals as in claim 1, wherein each antenna connects to a receiver.

4. A system for finding the instantaneous spatial direction of a source of radio signals as in claim 1, wherein each receiver generates in response to a signal received from an antenna, two output signals at a frequency within the operating bandwidth of half the clock frequency, and wherein the phase difference between the two signals is about 90°.

5. A system for finding the instantaneous spatial direction of a source of radio signals as in claim 1, wherein each phase digitizer connects to one receiver, and generates in response to signals received from the receiver a digital output indicative of the instantaneous phase of the signals received from the receiver, at the instance of the transition of an instruction clock pulse.

6. A system for finding the instantaneous spatial direction of a source of radio signals as in claim 1, wherein the devices used to calculate the phase differences between antennas comprise of digital subteractors and adders.

7. A system for finding the instantaneous spatial direction of a source of radio signals as in claim 1, wherein the instantaneous frequency can be calculated by digitally obtaining of the phase difference in a signal received, over a span of a single clock period.

8. A system for finding the instantaneous spatial direction of a source of radio signals as in claim 1, wherein the results of frequency and phase differences calculations may be improved by averaging of digital data generated over a plurality of clock periods.

9. A system for finding the instantaneous spatial azimuth and elevation of a source of radio signals comprising
A plurality of antennas on a horizontal plane;
An additional antenna;
A plurality of Radio Frequencies receivers, equal the number of antennas;
A plutality of phase digitizers, equal the number of antennas;
Devices to digitally calculate the the phase difference between ant two antennas;
Devices to digitally calculate the instantaneous frequency of a detected signal;
Devices to digitally calculate, from frequency and phase differences data, the azimuth of a source of radio signal.

10. A system for finding the instantaneous spatial azimuth and elevation of a source of radio signals as in claim 9, wherein the plurality of antennas on a horizontal plane is a minimum of three antennas

11. A system for finding the instantaneous spatial azimuth and elevation of a source of radio signals as in claim 9, wherein an additional antenna is erected on a vertical axis common with one antenna on the horizontal plane.

12. A system for finding the instantaneous spatial azimuth and elevation of a source of radio signals as in claim 9, wherein each antenna connects to a receiver.

13. A system for finding the instantaneous spatial azimuth and elevation of a source of radio signals as in claim 9, wherein each receiver generates in response to a signal received from an antenna, two output signals at a frequency within the operating bandwidth of half the clock frequency, and wherein the phase difference between the two signals is about 90°.

14. A system for finding the instantaneous spatial azimuth and elevation of a source of radio signals as in claim 9, wherein each phase digitizer connects to one receiver, and generates in response to signals received from the receiver a digital output indicative of the instantaneous phase of the signals received from the receiver, at the instance of the transition of an instruction clock pulse.

15. A system for finding the instantaneous spatial azimuth and elevation of a source of radio signals as in claim 9, wherein the devices used to calculate the phase differences between antennas comprise of digital subteractors and adders.

16. A system for finding the instantaneous spatial azimuth and elevation of a source of radio signals as in claim 9, wherein the instantaneous frequency can be calculated by digitally obtaining of the phase difference in a signal received, over a span of a single clock period.

17. A system for finding the instantaneous spatial azimuth and elevation of a source of radio signals as in claim 9, wherein the results of frequency and phase differences calculations may be improved by averaging of digital data generated over a plurality of clock periods.

18. A system for finding the instantaneous spatial direction of a source of radio signals comprising
A four antennas;
A four Radio Frequencies receivers;
A four phase digitizers;
Devices to digitally calculate the the phase difference between ant two antennas;
Devices to digitally calculate the instantaneous frequency of a detected signal;
Devices to digitally calculate, from frequency and phase differences data, the azimuth of a source of radio signal.

19. A system for finding the instantaneous spatial direction of a source of radio signals as in claim 18, wherein four antennas are mounted on a horizontal plane.

20. A system for finding the instantaneous spatial direction of a source of radio signals as in claim 18, wherein four antennas are mounted on a horizontal plane as two pairs of antennas wherein each pair of antennas is mounted on one common axis, and further wherein the axes of the two pairs of antennas are perpendicular to each other.

21. A system for finding the instantaneous spatial direction of a source of radio signals as in claim 18, wherein each antenna connects to a receiver.

22. A system for finding the instantaneous spatial direction of a source of radio signals as in claim 18, wherein each receiver generates in response to a signal received from an antenna, two output signals at a frequency within the operating bandwidth of half the clock frequency, and wherein the phase difference between the two signals is about 90°.

23. A system for finding the instantaneous spatial direction of a source of radio signals as in claim 18, wherein each phase digitizer connects to one receiver, and generates in response to signals received from the receiver a digital output indicative of the instantaneous phase of the signals received from the receiver, at the instance of the transition of an instruction clock pulse.

24. A system for finding the instantaneous spatial direction of a source of radio signals as in claim 18, wherein the devices used to calculate the phase differences between antennas comprise of digital subteractors and adders.

25. A system for finding the instantaneous spatial direction of a source of radio signals as in claim 18, wherein the instantaneous frequency can be calculated by digitally obtaining of the phase difference in a signal received, over a span of a single clock period.

26. A system for finding the instantaneous spatial direction of a source of radio signals as in claim 18, wherein the results of frequency and phase differences calculations may be improved by averaging of digital data generated over a plurality of clock periods.

27. A system for finding the instantaneous spatial azimuth and elevation of a source of radio signals comprising
Four antennas on a horizontal plane;
An additional antenna;
A four Radio Frequencies receivers;
A four phase digitizers;
Devices to digitally calculate the the phase difference between ant two antennas;
Devices to digitally calculate the instantaneous frequency of a detected signal;
Devices to digitally calculate, from frequency and phase differences data, the azimuth of a source of radio signal.

28. A system for finding the instantaneous spatial azimuth and elevation of a source of radio signals as in claim 27, wherein four antennas are mounted on a horizontal planeas two pairs of antennas wherein each pair of antennas is mounted on one common axis, and further wherein the axes of the two pairs of antennas are perpendicular to each other.

29. A system for finding the instantaneous spatial azimuth and elevation of a source of radio signals as in claim 27, wherein an additional antenna is erected on a vertical axis common with one antenna on the horizontal plane.

30. A system for finding the instantaneous spatial azimuth and elevation of a source of radio signals as in claim 27, wherein each antenna connects to a receiver.

31. A system for finding the instantaneous spatial azimuth and elevation of a source of radio signals as in claim 27, wherein each receiver generates in response to a signal received from an antenna, two output signals at a frequency within the operating bandwidth of half the clock frequency, and wherein the phase difference between the two signals is about 90°.

32. A system for finding the instantaneous spatial azimuth and elevation of a source of radio signals as in claim 27, wherein each phase digitizer connects to one receiver, and generates in response to signals received from the receiver a digital output indicative of the instantaneous phase of the signals received from the receiver, at the instance of the transition of an instruction clock pulse.

33. A system for finding the instantaneous spatial azimuth and elevation of a source of radio signals as in claim 27, wherein the devices used to calculate the phase differences between antennas comprise of digital subteractors and adders.

34. A system for finding the instantaneous spatial azimuth and elevation of a source of radio signals as in claim 27, wherein the instantaneous frequency can be calculated by digitally obtaining of the phase difference in a signal received, over a span of a single clock period.

35. A system for finding the instantaneous spatial azimuth and elevation of a source of radio signals as in claim 27, wherein the results of frequency and phase differences calculations may be improved by averaging of digital data generated over a plurality of clock periods.

36. A system for finding the instantaneous spatial direction of a source of radio signals comprising
Two directional antennas;
Two radio signals receivers, equal the number of antennas;
Two phase digitizers, equal the number of antennas;
Devices to digitally calculate the the phase difference between the two antennas;
Devices to digitally calculate the instantaneous frequency of a detected signal;
Devices to digitally calculate, from frequency and phase differences data, the azimuth of a source of radio signal.

37. A system for finding the instantaneous spatial direction of a source of radio signals as in claim 36, wherein each antenna connects to a receiver.

38. A system for finding the instantaneous spatial direction of a source of radio signals as in claim 36, wherein each receiver generates in response to a signal received from an antenna, two output signals at a frequency within the operating bandwidth of half the clock frequency, and wherein the phase difference between the two signals is about 90°.

39. A system for finding the instantaneous spatial direction of a source of radio signals as in claim 36, wherein each phase digitizer connects to one receiver, and generates in response to signals received from the receiver a digital output indicative of the instantaneous phase of the signals received from the receiver, at the instance of the transition of an instruction clock pulse.

40. A system for finding the instantaneous spatial direction of a source of radio signals as in claim 36, wherein the devices used to calculate the phase differences between antennas comprise of digital subtractors and adders.

41. A system for finding the instantaneous spatial direction of a source of radio signals as in claim 36, wherein the instantaneous frequency can be calculated by digitally obtaining of the phase difference in a signal received, over a span of a single clock period.

42. A system for finding the instantaneous spatial direction of a source of radio signals as in claim 36, wherein the results of frequency and phase differences calculations may be improved by averaging of digital data generated over a plurality of clock periods.

43. A monopulse type radar system comprised of one, two, or three directional antennas, wherein the instantaneous phase of received radio signals is mesured using phase digitizers.

44. A “cross-eye” radar deception system comprised of Two directional antennas;
Two radio signals receivers;
Two phase digitizer;
Two temporary memories;
Two digital phase shifters;
A common digital signal processing and control unit.

45. A “cross-eye” radar deception system as in claim 44, wherein the instantaneous phase of a signal received on the antanna is measure utilizing a phase digitizer.

46. A “cross-eye” radar deception system as in claim 44, wherein the temporary memory stores consecutive samples of the instantaneous phase of the signal received on the antenna.

47. A “cross-eye” radar deception system as in claim 44, wherein instantaneous phase data stored in the memory, can be read back from the temporary memory in the same order in which that data was stored in the memory, and wherein such readback may comrise of a one time readback, or repeated head to tail readbacks.

48. A “cross-eye” radar deception system as in claim 44, wherein the the common digital signal processing and control unit receives the digital presentation of the insatntaneous phase of radio signals received on both antennas and digitized by the corresponding phase digitizers, and wherein the digital signal processing unit measures the instantaneous phase difference between signals received on both antennas, and controls the digital phase shifters.

49. A “cross-eye” radar deception system as in claim 44, wherein the digital phase shifters receive digital phase shift commands from the digital signal processing unit and in response modifies the data readback from the memory to cause a shift in the phase of the signal at the output of a phase to analog converter.

50. A “cross-eye” radar deception system as in claim 44, wherein the phase to analog converters receives instantaneous phase data from the digital phase shifter and convert that data into a succession of analog pulses of an amplitude directly proportional to the arcsine of the instantaneous phase as presented by the instantaneous phase data at the input to the converter.
